(19) United States
(12) Patent Application Publication
(10) Pub. No.: US 2025/0290686 A1
(43) Pub. Date: Sep. 18, 2025

(54) REFRIGERATOR

(71) Applicant: LG ELECTRONICS INC., Seoul (KR)

(72) Inventors: Sunkook JI, Seoul (KR); Kiyoung LIM, Seoul (KR)

(21) Appl. No.: 19/052,448

(22) Filed: Feb. 13, 2025

(30) Foreign Application Priority Data
Mar. 18, 2024 (KR) 1020-2024-0037312

(51) Int. Cl. F25D 23/02

(52) U.S. Cl. CPC F25D 23/028; F25D 23/025; F25D 2323/023; F25D 2700/02

(57) ABSTRACT

A refrigerator is provided. According to one embodiment, the refrigerator includes a cabinet forming a storage space; and a door rotatably connected to the cabinet, in which the door includes a main-door part rotatably coupled to the cabinet; a sub-door part rotatably coupled to the main-door part; a latch accommodation part provided at a lower end part of the main-door part; a latch member provided at a lower end part of the sub-door part and detachably engaged to the latch accommodation part; a first space-maintaining member provided on an upper end part of the main-door part; and a second space-maintaining member provided on an upper end part of the sub-door part and disposed facing the first space-maintaining member.

### CROSS-REFERENCE TO RELATED PATENT APPLICATIONS

This application claims priority to Korean Patent Application No. 10-2024-0037312, filed Mar. 18, 2024, whose entire disclosures are hereby incorporated by reference.

### BACKGROUND

The present disclosure relates to a refrigerator.

In general, a refrigerator is a home appliance that can store food at low temperatures in an internal storage space that is shielded by a door. To this end, the refrigerator is configured to cool the inside of the storage space by using cold air generated through heat exchange with a refrigerant that circulates a refrigeration cycle, thereby allowing the stored food to be stored in an optimal condition.

Recently, refrigerators are becoming larger and more multifunctional in line with the changing eating habits and the trend toward higher quality products, and refrigerators equipped with various structures and convenient devices for the convenience of users and efficient use of internal space are being released.

For example, a refrigerator is being released that has a door that includes a main-door part that can rotate with respect to a cabinet and has a storage space formed therein, and a sub-door part that can rotate with respect to the main-door part and opens and closes the storage space formed in the main-door part.

The sub-door part can be fixed to the main-door part in a closed state through the restraint of the latch member provided in the sub-door part and the latch accommodation part formed in the main-door part. The restraint between the latch member and the latch accommodation part can be released by the user's manipulation.

The conventional latch accommodation part was generally located in the center of the main-door part to prevent gap deviation between the main-door part and the sub-door part. However, the structure is not hygienic because foreign substances can enter the latch accommodation part, and is not aesthetically pleasing because the latch accommodation part is located in the user's line of sight.

### SUMMARY

An object of an embodiment of the present disclosure is to provide a refrigerator having a door with an improved outer appearance, in which a latch accommodation part is located away from a user's main line of sight in a double door structure including a main-door part and a sub-door part.

An object of an embodiment of the present disclosure is to provide a refrigerator having a double door structure including a main-door part and a sub-door part, wherein a latch accommodation part is located at the lower end part of the main-door part, thereby providing a hygienically improved door.

An object of an embodiment of the present disclosure is to provide a refrigerator having a double door structure including a main-door part and a sub-door part, wherein a latch accommodation part is located at the lower end part of the main-door part, and gap deviation between the main-door part and the sub-door part is minimized to improve the outer appearance and enhance the refrigeration efficiency.

A refrigerator according to an embodiment for solving the problem includes a cabinet forming a storage space; and a door rotatably connected to the cabinet, in which the door includes a main-door part rotatably coupled to the cabinet; a sub-door part rotatably coupled to the main-door part; a latch accommodation part provided at a lower end of the main-door part; a latch member provided at a lower end of the sub-door part and detachably engaged to the latch accommodation part; a first space-maintaining member provided on an upper end of the main-door part; and a second space-maintaining member provided on an upper end of the sub-door part and disposed facing the first space-maintaining member.

The first space-maintaining member and the second space-maintaining member may be magnets forming a mutual attractive force.

One of the first space-maintaining member and the second space-maintaining member may be a magnet, and the other of the first space-maintaining member and the second space-maintaining member may be a magnetic material forming an attractive force with the magnet.

The refrigerator may further include a detection member provided in the latch accommodation part and detecting an engagement between the latch member and the latch accommodation part; and a control part controlling the first space-maintaining member based on information provided from the detection member, in which the first space-maintaining member may be an electromagnet, the second space-maintaining member may be a magnetic material configured to form an attractive force with a magnet, and the control part may control so that the first space-maintaining member has a magnetic force when the latch member and the latch accommodation part are engaged, and so that the first space-maintaining member does not have a magnetic force when the engagement of the latch member and the latch accommodation part is released.

In a state where the latch member and the latch accommodation part are mutually engaged, a distance between the first space-maintaining member and the second space-maintaining member may be minimum.

The main-door part may include a door frame provided on a front surface of the main-door and including a first accommodation part in which the first space-maintaining member provided; and a frame cover coupled to a front surface of the door frame and configured to shield the first accommodation part.

The sub-door part may include a panel; a sub-door liner to which the panel is coupled and forming a rear surface of the sub-door part; an upper bracket forming an upper surface of the sub-door part; a lower bracket forming the lower surface of the sub-door part; and an insulation material formed by filling a foam liquid in a space formed by the coupling of the panel, the sub-door liner, the upper bracket, and the lower bracket, a second accommodation part having the second space-maintaining member may be formed on a front surface of the sub-door liner, and the second accommodation part may be shielded by a shielding member to prevent penetration of the insulation material.

The panel may include a see-through part configured to be viewable inside; and a bezel part disposed to surround the see-through part, and the second space-maintaining member may be disposed at the rear of the bezel part.

The first space-maintaining member and the second space-maintaining member may be magnets forming a mutual attraction force, and the shielding member may be made of a material through which magnetic fields can pass.

The latch member may include a latch housing mounted on the lower bracket; and a manipulation member rotatably coupled to the latch housing and engaging with and disengaging from the latch accommodation part by a user's manipulation.

The main-door part may include a door liner forming a rear surface of the main-door part; a side frame forming a side of the main-door part; an upper cap decoration forming an upper surface of the main-door part; and a lower cap decoration forming a lower surface of the main-door part, and the latch accommodation part may be mounted on the lower cap decoration.

At a lower end of the frame cover, a cover cutout part may be formed that is recessed upward so that the latch accommodation part is partially inserted, and the latch member may be engaged to the latch accommodation part through the cover cutout part.

The latch accommodation part may be located at a lower part of a lower end of the frame cover.

At the lower end of the frame cover, a cover hole may be formed so that the latch accommodation part is exposed forward, and the latch member may be engaged to the latch accommodation part through the cover hole.

The first accommodation part may be located in front of the upper cap decoration.

The latch accommodation part may include a latch restraint part in which the latch member is engaged; a latch insertion part inserted into a lower end part of the door frame and restrained from moving in a front and rear direction; and a latch mounting part formed to protrude to one side from the latch restraint part and mounted on the lower cap decoration.

The first space-maintaining member and the second space-maintaining member may be magnets forming a mutual attraction force, and the frame cover may be made of a material through which magnetic fields pass.

The following effects can be expected from the refrigerator according to the proposed embodiment.

According to an embodiment of the present disclosure, in a refrigerator having a double door structure consisting of a main-door part and a sub-door part, the latch accommodation part may be located at the lower end part of the main-door part. Accordingly, since the latch accommodation part is not visible to the user, the outer appearance of the door can be improved. In addition, hygiene can be improved by preventing foreign substances from entering the latch accommodation part.

An embodiment of the present disclosure includes a double door structure including a main-door part and a sub-door part, in a door in which the latch accommodation part is located at the lower end part of the main-door part, by providing a space-maintaining member at the upper end part of the main-door part and the sub-door part, the gap deviation between the main-door part and the sub-door part can be minimized, thereby improving the outer appearance and enhancing the refrigeration efficiency.

### BRIEF DESCRIPTION OF THE DRAWINGS

FIG. 1 is a perspective view illustrating a refrigerator according to one embodiment.

FIG. 2 is a view illustrating a state where a door of a refrigerator according to one embodiment opens.

FIG. 3 is a front view illustrating a refrigerator door according to one embodiment.

FIG. 4 is an exploded perspective view illustrating a refrigerator door according to one embodiment.

FIG. 5 is an exploded perspective view illustrating a main-door part according to one embodiment.

FIG. 6 is a cross-sectional view taken along line 6-6 of FIG. 3.

FIG. 7 is a partial bottom view illustrating a door according to one embodiment.

FIG. 8 is a cross-sectional view taken along line 8-8 of FIG. 3.

FIG. 9 is a partial cross-sectional view illustrating a door according to another embodiment.

FIG. 10 is a partial cross-sectional view illustrating a door according to another embodiment.

FIG. 11 is a control block diagram illustrating a door according to another embodiment.

FIG. 12 is a partial cross-sectional view illustrating a door according to an embodiment of FIG. 11.

FIG. 13 is a partial cross-sectional view illustrating a door according to another embodiment.

FIG. 14 is a partial cross-sectional view illustrating a door according to another embodiment.

### DETAILED DESCRIPTION OF THE EMBODIMENTS

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

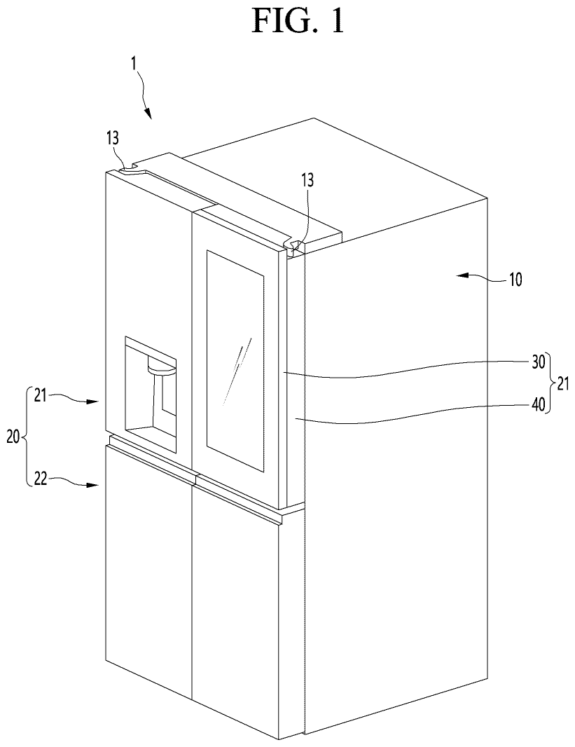

Before explanation, the direction is defined. In the embodiment of the present disclosure, the direction in which the front surface of the door as illustrated in FIG. 1 faces can be defined as forward, the direction toward the cabinet based on the front surface of the door can be defined as rearward, the direction toward the floor surface on which the refrigerator is installed can be defined as downward, and the direction away from the floor surface can be defined as upward.

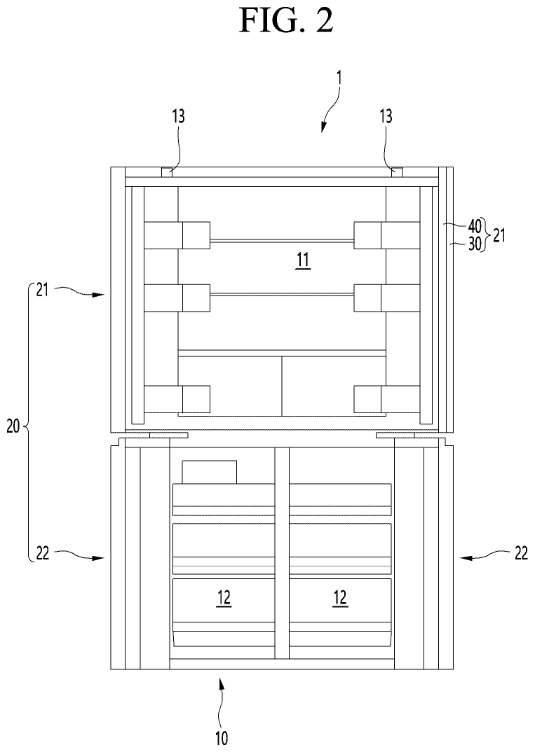

FIG. 1 is a perspective view illustrating a refrigerator according to one embodiment, and FIG. 2 is a view illustrating a state where a door of a refrigerator according to one embodiment opens.

Referring to FIGS. 1 and 2, A refrigerator 1 according to one embodiment includes a cabinet 10 in which a storage space is formed and a door 20 for opening and closing the storage space. For example, the storage space may be partitioned vertically, and a refrigerating compartment 11 may be provided at the upper part and a freezing compartment 12 may be provided at the lower part.

For example, the refrigerating compartment 11 is configured as a single space and can be opened and closed by a pair of refrigerating compartment doors 21. A freezing compartment 12 can be provided at the upper part of the refrigerating compartment 11. The freezing compartment 12 can be divided into left and right sides to form independent storage spaces, respectively, and can be controlled at different temperatures. The freezing compartment 12 can be opened and closed by a pair of freezing compartment doors 22, respectively. The refrigerating compartment 11 can be referred to as an upper storage space, and the freezing compartment 12 can be referred to as a lower storage space.

The door 20 may include a refrigerating compartment door 21 configured to open and close the refrigerating compartment 11 and a freezing compartment door 22 configured to open and close the freezing compartment 12. The refrigerating compartment door 21 and the freezing compartment door 22 may each be provided as a pair on the left and right sides. The refrigerating compartment door 21 may be referred to as an upper door, and the freezing compartment door 22 may be referred to as a lower door.

The upper end and the lower end of the door 20 may be provided with a main hinge 13. The door 20 may be rotatably connected to the cabinet 10 via the main hinge 13. In addition, some of the doors among the entire doors 20 may be configured to be connected and rotated by the main hinge 13, and other doors may be configured to slide in and out.

At least one of the doors 20 may be configured with a double door structure. For example, the refrigerating compartment door 21 may be configured with a double door structure including a main-door part 40 and a sub-door part 30. Hereinafter, the description will be made based on the refrigerating compartment door 21 among the doors 20 in relation to the embodiment of the present disclosure, but the contents thereof may also be applied to the freezing compartment door 22.

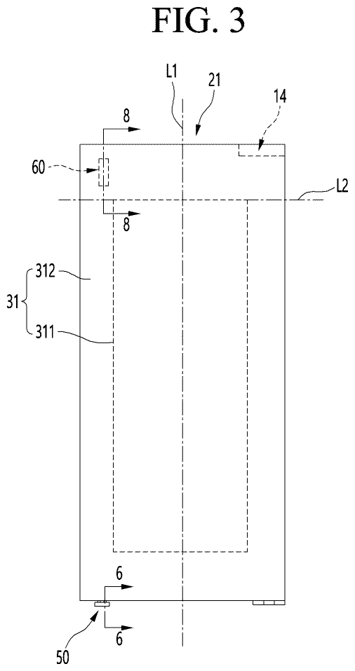

Below, the detailed structure of the refrigerating compartment door 21 will be described with reference to FIGS. 3 to 5.

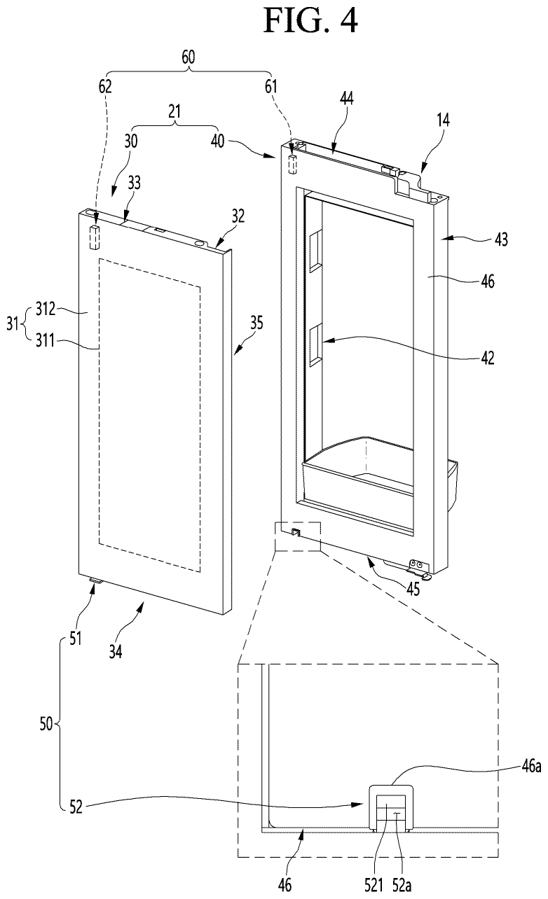

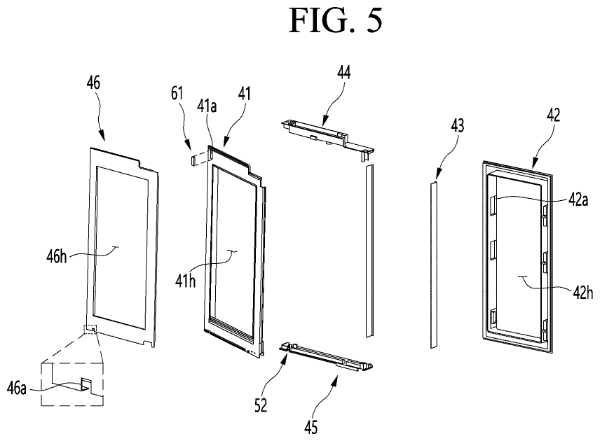

FIG. 3 is a front view illustrating a refrigerator door according to one embodiment, FIG. 4 is an exploded perspective view illustrating a refrigerator door according to one embodiment, and FIG. 5 is an exploded perspective view illustrating a main-door part according to one embodiment.

Referring to FIGS. 3 to 5, According to one embodiment, a refrigerating compartment door 21 may include a main-door part 40 rotatably connected to a cabinet 10 and a sub-door part 30 rotatably connected to the main-door part 40.

According to one embodiment, a refrigerating compartment door 21 may further include a latch assembly 50 provided at the lower end part to mutually engage the lower end parts of the sub-door part 30 and the main-door part 40, and a space-maintaining member 60 provided at the upper end part to maintain space between the upper end parts of the sub-door part 30 and the main-door part 40.

The latch assembly 50 may include a latch member 51 provided at the lower end of the sub-door part 30 and a latch accommodation part 52 provided at the lower end of the main-door part 40. The space-maintaining member 60 may include a first space-maintaining member 61 provided at the main-door part 40 side and a second space-maintaining member 62 provided at the sub-door part 30 side.

The main-door part 40 can be axially coupled to the cabinet 10. For example, the main-door part 40 is rotatably connected to the cabinet 10 by the main hinge 13, and the refrigerating compartment 11 can be opened and closed through the rotational motion.

The main-door part 40 may include a door frame 41 forming the front surface of the main-door part 40, a main-door liner 42 forming the rear surface of the main-door part 40, side decorations 43 forming both sides of the main-door part 40, an upper cap decoration 44 forming the upper surface of the main-door part 40, a lower cap decoration 45 forming the lower surface of the main-door part 40, and a front cover 46 covering the door frame 41 from the front. The internal space of the main-door part 40 defined by the door frame 41, the main-door liner 42, the side decoration 43, the upper cap decoration 44, and the lower cap decoration 45 may be filled with an insulation material.

The door frame 41 may include a frame opening 41h formed by opening forward and rearward. A first accommodation part 41a for accommodating a first space-maintaining member 61 described later may be formed at the upper end part of the door frame 41. The first accommodation part 41a may be formed by being recessed a part of the front surface of the door frame 41 toward the rear.

The main-door liner 42 can be coupled to the rear of the door frame 41. The main-door liner 42 may include a main-door liner opening 42h formed by opening forward and rearward. The main-door liner opening 42h can be aligned to communicate with the frame opening 41h. In the main-door liner 42, a storage member coupling part 42a to which a door storage member can be coupled can be formed on the inner surface defining the main-door liner opening 42h.

A pair of side decorations 43 are provided. The side decoration can have a shape that extends in the vertical direction. The side decoration 43 can connect both sides of the door frame 41 and the main-door liner 42. For example, The side decorations 43 can shield the space between the door frame 41 and the main-door liner 42 on both sides.

The upper cap decoration 44 can form the upper surface of the main-door part 40. The upper cap decoration 44 can be coupled between the upper end of the door frame 41 and the upper end of the main-door liner 42.

The lower cap decoration 45 can form the lower surface of the main-door part 40. The lower cap decoration 45 can be coupled between the lower end of the door frame 41 and the lower end of the main-door liner 42.

The lower cap decoration 45 can be equipped with a latch accommodation part 52. The latch accommodation part 52 is formed as a module in which the latch member 51 can be engaged and thus can be mounted on the lower surface of the lower cap decoration 45. The latch accommodation part 52 can be located on the opposite side of the rotation axis of the sub-door part 30. Therefore, through the structure, the sub-door part 30 can be stably fixed to the main-door part 40.

A frame cover 46 may be mounted on the front of the door frame 41. The frame cover 46 may cover the front surface of the door frame 41. Specifically, the frame cover 46 may shield the first accommodation part 41a formed on the upper end of the door frame 41 and in which the first space-maintaining member 61 is accommodated from the front. Accordingly, the first space-maintaining member 61 is not exposed to the front, and the position thereof may be fixed.

For example, the first space-maintaining member 61 may be composed of a magnet. Accordingly, the frame cover 46 may be made of a material that does not block a magnetic field. For example, the frame cover 46 may be made of a plastic injection molded product or a metal material that does not shield a magnetic field.

The frame cover 46 may include a cover opening 46h formed by opening in the front and rear direction. The cover opening 46h can be aligned to communicate with the frame opening 41h and the main-door liner opening 42h.

The frame cover 46 may further include a cover cutout part 46a cut upward from the lower end. Through the cover cutout part 46a, the latch accommodation part 52 coupled to the lower cap decoration 45 may be exposed forward. For example, the front end of the latch accommodation part 52 may be partially inserted into the cover cutout part 46a and exposed forward.

Through the cover cutout part 46a of the frame cover 46, the latch accommodation space 52a of the latch accommodation part 52 where the latch member 51 is engaged can be exposed forward. In addition, through the cover cutout part 46a of the frame cover 46, the front surface of the latch restraint part 521 where the latch member 51 is engaged can be exposed forward.

The above-described cover opening 46h, frame opening 41h, and main-door liner opening 42h can form an opening of the main-door part 40. The opening of the main-door part 40 penetrates the main-door part 40 in the front and rear direction and can be communicated with the refrigerating compartment 11. Therefore, even when the main-door part 40 is closed, the refrigerating compartment 11 can be accessed through the opening of the main-door part 40.

The sub-door part 30 can be axially coupled to the main-door part 40 through the sub hinge 14. In other words, the sub hinge 14 can form a rotation axis of the sub-door part 30. The sub-door part 30 can shield the main-door part 40 from the front by rotation. Specifically, the sub-door part 30 can open and close the opening of the main-door part 40.

The sub-door part 30 may include a panel 31 forming the front surface, a sub-door liner 32 forming the rear surface, an upper bracket 33 forming the upper surface, and a lower bracket 34 forming the lower surface.

The panel 31 may be configured to allow the refrigerating compartment 11 at the rear of the refrigerating compartment door 21 to see through. For example, the panel 31 may be provided on both refrigerating compartment doors 21 or on one of the refrigerating compartment doors 21 on both sides.

In addition, the panel 31 may be equipped with a transparent display to enable screen output. Accordingly, the sub-door part 30 may be configured to enable both see-through and screen output of the storage space 11 through the panel 31.

For example, the panel 31 may include a see-through part 311 configured to see through and a bezel part 312 disposed around the see-through part 311. The bezel part 312 may be disposed to surround the see-through part 311. Meanwhile, when a transparent display is provided on the panel 31, the see-through part 311 may be an area where a screen is output.

The upper bracket 33 forms the upper surface of the sub-door part 30, and the lower bracket 34 can form the lower surface of the sub-door part 30. A pair of side brackets 35 disposed on the left and right sides of the sub-door part 30 can form the left and right sides of the sub-door part 30. The side brackets 35 can connect the end parts of the upper bracket 33 and the lower bracket 34 on both sides.

A second space-maintaining member 62 may be provided on the sub-door part 30. For example, the second space-maintaining member 62 may be mounted on the sub-door liner 32. The second space-maintaining member 62 may be placed at the rear of the bezel part 312 of the panel 31.

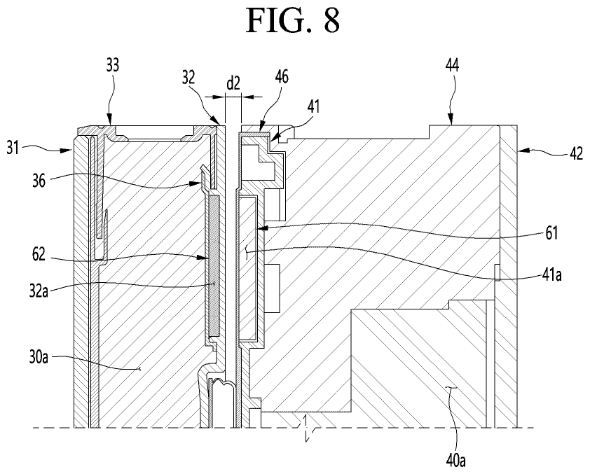

The second space-maintaining member 62 can, together with the first space-maintaining member 61, form a space-maintaining member 60 that maintains the space between the upper end part of the sub-door part 30 and the main-door part 40. The detailed mounting structure of the second space-maintaining member 62 will be described later with reference to FIG. 8.

The lower bracket 34 can be equipped with a latch member 51. The latch member 51 is formed as a module that can be engaged in the latch accommodation part 52 and thus can be mounted on the lower surface of the lower bracket 34. The lower bracket 34 may include a lower bracket groove 34a for accommodating a latch member 51 to be mounted thereon. The lower bracket groove 34a can be formed by being recessed upward from the lower surface of the lower bracket 34.

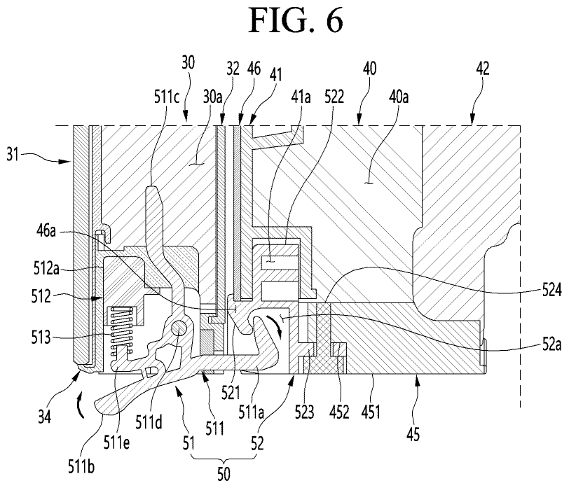

The latch member 51 may be located on the opposite side of the rotation axis of the sub-door part 30. Therefore, through the structure, the sub-door part 30 can be stably fixed to the main-door part 40. The mounting structure of the latch member 51 will be described later with reference to FIG. 6.

An upper bracket 33, a lower bracket 34, and a pair of side brackets 35 are coupled with each other to form a rectangular frame shape, and can form a peripheral surface of a sub-door part 30. The rear ends of the upper bracket 33, the lower bracket 34, and the pair of side brackets 35 can be coupled with a sub-door liner 32, and the front ends can be coupled with a panel 31. In a state where the panel 31, the sub-door liner 32, the upper bracket 33, the lower bracket 34, and the side brackets 35 are coupled, an insulation material can be filled in the internal space of the sub-door part 30. The insulation material can be in contact with the peripheral surface of the panel 31.

The latch assembly 50 may include a latch member 51 mounted on the lower bracket 34 of the sub-door part 30 and a latch accommodation part 52 mounted on the lower cap decoration 45 of the main-door part 40.

Specifically, When the sub-door part 30 is closed against the main-door part 40, The latch member 51 may be engaged by the latch accommodation part 52, thereby restricting the opening of the sub-door part 30. Meanwhile, when the latch member 51 is manipulated to release the restraint on the latch accommodation part 52, the sub-door part 30 can be opened relative to the main-door part 40.

When the sub-door part 30 is closed against the main-door part 40, the lower end part can be fixed by being engaged by the latch member 51 and the latch accommodation part 52, as described above.

Meanwhile, the space between the upper end parts of the main-door part 40 and the sub-door part 30 can be maintained through a space-maintaining member 60. For example, the space between the upper end parts of the main-door part 40 and the sub-door part 30 can be maintained substantially the same as the space between the lower end parts through the space-maintaining member 60. In other words, the space-maintaining member 60 can reduce the separation deviation between the upper and lower end parts of the main-door part 40 and the sub-door part 30.

The left and right positions of the space-maintaining member 60 may be set to be located on one side based on the first virtual line L1 that divides the refrigerating compartment door 21 into left and right halves. The first virtual line L1 may extend in the vertical direction of the refrigerating compartment door 2). On the other side of the refrigerator door 21 based on the first virtual line L1, the sub-hinge 14 may be located. In other words, the space-maintaining member 60 may be located on the opposite side of the sub-hinge 14 based on the first virtual line L1 that divides the refrigerating compartment door 21 into left and right halves.

Meanwhile, the upper and lower positions of the space-maintaining member 60 may be set based on the second virtual line L2 extending along the upper end edge of the see-through part 311. The second virtual line L2 may extend in the left and right direction of the refrigerating compartment door 21. For example, the space-maintaining member 60 may be positioned above the second virtual line L2. In another embodiment, the space-maintaining member 60 may be disposed across the second virtual line L2. In other words, the upper end of the space-maintaining member 60 may be positioned above the second virtual line L2, while the lower end may be positioned below the second virtual line L2.

Through the above structure, the space-maintaining member 60 can further reduce the upper and lower end separation deviation between the main-door part 40 and the sub-door part 30.

The space-maintaining member 60 may include a first space-maintaining member 61 provided on the main-door part 40 side and a second space-maintaining member 62 provided on the sub-door part 30 side. At least one of the first space-maintaining member 61 and the second space-maintaining member 62 may be formed of a magnet.

For example, both the first space-maintaining member 61 and the second space-maintaining member 62 may be composed of magnets that form an attractive force with respect to each other. Alternatively, one of the first space-maintaining member 61 and the second space-maintaining member 62 may be a magnet, and the other may be composed of a metal material that forms an attractive force with respect to the magnet.

The first space-maintaining member 61 and the second space-maintaining member 62 may be disposed to face each other when the sub-door part 30 is closed relative to the main-door part 40. In addition, the first space-maintaining member 61 may be positioned on the inside of the main-door part 40 and may not be exposed to the outside. The second space-maintaining member 62 may be positioned on the inside of the sub-door part 30 and may not be exposed to the outside.

Hereinafter, the mounting structure of the latch assembly 50 and the space-maintaining member 60 will be described in detail with reference to FIGS. 6 to 8.

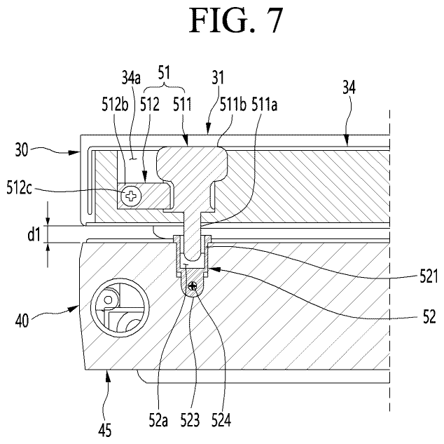

FIG. 6 is a cross-sectional view taken along line 6-6 of FIG. 3, and FIG. 7 is a partial bottom view illustrating a door according to one embodiment.

Referring to FIGS. 6 and 7 along with FIG. 3, a latch assembly 50 may be provided at the lower end part of the main door part 40 and the sub door part 30.

A latch member 51 may be provided at the lower end of the sub-door part 30. For example, the latch member 51 can be mounted on the lower bracket 34 of the sub-door part 30.

The latch member 51 may include a manipulation member 511, a latch housing 512 to which the manipulation member 511 is coupled, and an elastic member 513 that presses the manipulation member 511 against the latch housing 512.

The manipulation member 511 can be rotatably coupled to the latch housing 512. The manipulation member 511 can include a hook part 511a that extends rearwardly and is engaged to the latch accommodation part 52, a handle part 511b that extends forwardly and is provided for the user's manipulation, a rotation restriction part 511c that extends upwardly and restricts the rotation of the manipulation member 511, a rotation shaft 511d that constitutes the center of rotation of the manipulation member 511, and an elastic member support part 511e that is positioned adjacent to the handle part 511b and is pressed by one side of the elastic member 513.

The hook part 511a may have a shape extending rearward from the rotation shaft 511d. The hook part 511a may include a bent end part to be engaged into the latch restraint part 521 of the latch accommodation part 52. For example, In the process of closing the sub-door part 30, the hook part 511a can come into contact with the front surface of the latch restraint part 521 and move rearward to be engaged with the latch restraint part 521. When the manipulation member 511 rotates by manipulation through the manipulation part 511b, the hook part 511a can be released from the latch restraint part 521.

The manipulation part 511b may have a shape extending forward from the rotation shaft 511d. The manipulation part 511b can be moved up and down by the user's manipulation. By moving the manipulation part 511b up and down, the hook part 511a can be released. For example, in a state where the sub-door part 30 is closed to the main-door part 40, when the manipulation part 511b is moved upward, the manipulation member 511 rotates around the rotation shaft 511d, so that the restraint of the hook part 511a with respect to the latch restraint part 521 can be released.

The rotation restriction part 511c may have a shape extending upward from the rotation shaft 511d. The rotation restriction part 511c can restrict the rotation of the manipulation member 511 pressed by the elastic member 513. With the sub-door 30 open, the rotation restriction part 511c can be restricted to the main body part 512a of the latch housing 512 to restrict the rotation of the manipulation member 511. In other words, with the sub-door 30 open, the rotation restriction part 511c is restricted to the main body part 512a of the latch housing 512 to prevent the rotation of the manipulation member 511 (based on FIG. 6, counterclockwise) may be restricted.

The rotation shaft 511d can be rotatably coupled to the latch housing 512. The center of rotation of the manipulation member 511 can be configured.

The elastic member support part 511e may have a shape extending forward from the rotation shaft 511d. For example, the elastic member support part 511e may be located above the manipulation part 511b. The elastic member support part 511e is in contact with one side of the elastic member 513 and thus may be a configuration pressurized by an elastic member 513. Through this, rotation of the manipulation member 511 (based on FIG. 6, counterclockwise) can be achieved. Meanwhile, when the user moves the manipulation part 511b upward, the elastic member support part 511e can contract by pressurizing the elastic member 513.

The latch housing 512 may include a main body part 512a to which a manipulation member 511 is rotatably coupled and a latch manipulation part 512b mounted on a lower bracket 34 of a sub-door part 30.

As described above, the main body part 512a can restrict the rotation of the manipulation member 511 by restricting the rotation restriction part 511c of the manipulation member 511. In addition, the main body part 512a can support the elastic member 513. In other words, the elastic member 513 is disposed between the main body part 512a and the elastic member support part 511e and can pressurize the manipulation member 511 to rotate.

In a state where the sub-door part 30 is open, the elastic member 513 supported by the main body part 512a presses the manipulation member 511 to rotate in one direction (based on FIG. 6, counterclockwise), and the main body part 512a can restrain the rotation restriction part 511c to limit the manipulation member 511 from rotating in one direction (based on FIG. 6, counterclockwise).

The latch mounting part 512b can be formed to protrude to one side from the main body part 512a. The latch mounting part 512b can be mounted on the lower bracket 34 of the sub-door part 30. The latch mounting part 512b can be mounted to the lower bracket 34 via the fastening member 512c. For example, the fastening member 512c may be a screw.

The latch accommodation part 52 may include a latch restraint part 521, a latch insertion part 522 provided on the upper side of the latch restraint part 521, and a latch fastening part 523 provided on the rear side of the latch restraint part 521.

As described above, The hook part 511a of the manipulation member 511 can be engaged by the latch restraint part 521. The latch restraint part 521 may include a protrusion shape protruding toward the lower rear. The front surface of the latch restraint part 521 may include an inclined surface that protrudes forward as it goes upward. Through this, during the process of closing the sub-door part 30, the hook part 511a moves along the inclined surface and then the latch restraint part 521 can be naturally engaged.

The latch insertion part 522 can be inserted into the frame groove 41a provided at the lower part of the door frame 41. The latch insertion part 522 can be inserted into the frame groove 41a of the door frame 41 to restrain movement of the latch accommodation part 52 in the front and rear direction. The shape of the latch insertion part 522 can be formed to correspond to the shape of the frame groove 41a.

The latch fastening part 523 can be formed to extend rearwardly from the latch restraint part 521. The latch fastening part 523 can be fastened to the lower cap decoration 45 by a fastening member 524.

Specifically, the lower cap decoration 45 may include a lower surface part 451 forming the lower surface of the main door part 40 and a lower cap decoration groove 452 formed by being recessed upward from the lower surface part 451. The latch fastening part 523 may be fastened to the lower cap decoration groove 452 by a fastening member 524.

In other words, the latch accommodation part 52 is partially inserted into the door frame 41 side and can be stably coupled to the lower end part of the main-door part 40 through a structure in which it is fastened to the lower cap decoration 45. The latch accommodation part 52 may not protrude downward with respect to the lower cap decoration 45. In addition, the latch accommodation part 52 is located at the lower end part of the main-door part 40, so that even if the sub-door part 30 is opened, it is not positioned in the user's main line of sight and is not easily recognized, so that the outer appearance of the main-door part 40 can be improved.

Meanwhile, when the sub-door part 30 is closed relative to the main-door part 40, the lower end parts of the sub-door part 30 and the main-door part 40 can be spaced apart from each other by a first space d1.

FIG. 8 is a cross-sectional view taken along line 8-8 of FIG. 3.

Referring to FIG. 8 along with FIG. 3, the space-maintaining member 60 may include a first space-maintaining member 61 provided on the main-door part 40 side and a second space-maintaining member 62 provided on the sub-door part 30 side.

The first space-maintaining member 61 can be accommodated inside the first accommodation part 41a formed on the front surface of the door frame 41. The first space-maintaining member 61 can be shielded by the frame cover 46. Therefore, the first space-maintaining member 61 may not be exposed to the outside.

The second space-maintaining member 62 can be accommodated inside the second accommodation part 32a formed on the front surface of the sub-door liner 32. The second space-maintaining member 62 can be shielded by the accommodation groove cover 36. The accommodation groove cover 36 can seal the second accommodation part 32a so that the insulation material filled in the internal space 30a of the sub-door part 30 does not penetrate toward the second space-maintaining member 62. For example, the accommodation groove cover 36 can be attached to the sub-door liner 32 by an adhesive material such as a tape.

For example, the second space-maintaining member 62 may be composed of a magnet. Accordingly, the sub-door liner 32 may be composed of a material that does not block a magnetic field. For example, the sub-door liner 32 may be composed of a plastic injection molded product.

The first space-maintaining member 61 and the second space-maintaining member 62 are disposed to face each other, and an attractive force can be applied between them. When the sub-door part 30 is closed, the distance between the first space-maintaining member 61 and the second space-maintaining member 62 can be minimized. When the latch member 51 and the latch accommodation part 52 are mutually coupled, the distance between the first space-maintaining member 61 and the second space-maintaining member 62 can be minimized.

In other words, due to the force acting between the first space-maintaining member 61 and the second space-maintaining member 62, the space between the upper end parts of the main-door part 40 and the sub-door part 30 can be formed small. For example, when the sub-door part 30 is closed with respect to the main-door part 40, the upper end parts of the sub-door part 30 and the main-door part 40 can be spaced apart from each other by a second space d2.

Through the first space-maintaining member 61 and the second space-maintaining member 62, the second space d2 can be formed to be substantially similar to the first space d1. In other words, the first space-maintaining member 61 and the second space-maintaining member 62 opposing each other can reduce the separation deviation between the upper and lower end parts of the sub-door part 30 and the main-door part 40. Accordingly, the outer appearance can be improved by minimizing the area-specific separation deviation between the main-door part 40 and the sub-door part 30 and reducing the possibility of cold air leakage, thereby improving refrigeration efficiency.

Hereinafter, another embodiment of the door 20 structure will be described. In the following embodiments, the description of the same configuration as the already described embodiment will be omitted or simplified, and the differences will be mainly described.

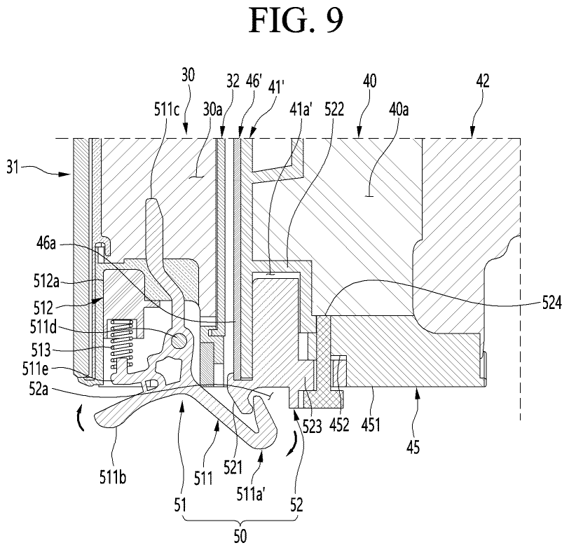

FIG. 9 is a partial cross-sectional view illustrating a door according to another embodiment.

Referring to FIG. 9, in this embodiment, the latch restraint part 521 of the latch accommodation part 52 may be located lower than the lower cap decoration 45 of the main-door part 40. In addition, the latch restraint part 521 may be located lower than the sub-door part 30.

In this embodiment, the frame cover 46′ may not include the cover cutout part 46a described above with reference to FIGS. 4 to 6. Accordingly, the latch restraint part 521 of the present embodiment can be placed at the lower part of the door frame 41′ and the frame cover 46′. The lower surface of the door frame 41′ and frame cover 46′ can be supported by a latch restraint part 521.

In this embodiment, The hook part 511a′ of the latch member 51 can be formed to correspond to the position of the latch retaining part 521. The hook part 511a′ may have a shape extending downwardly from the rotation shaft 511d.

According to the structure according to this embodiment, In the main-door part 40, the latch accommodation part 52 may be located at the lower part of the frame cover 46′ and may be less visible. In other words, since the latch accommodation part 52 is located away from the user's main line of sight, the outer appearance of the main-door part 40 can be further improved.

In addition, according to the structure according to the present embodiment, the latch accommodation part 52 can be introduced even without forming a cover cutout part 46a in the frame cover 46. In other words, according to the present embodiment, the latch accommodation part 52 can be applied even to a frame cover 46 in which the cover cutout part 46a is not formed.

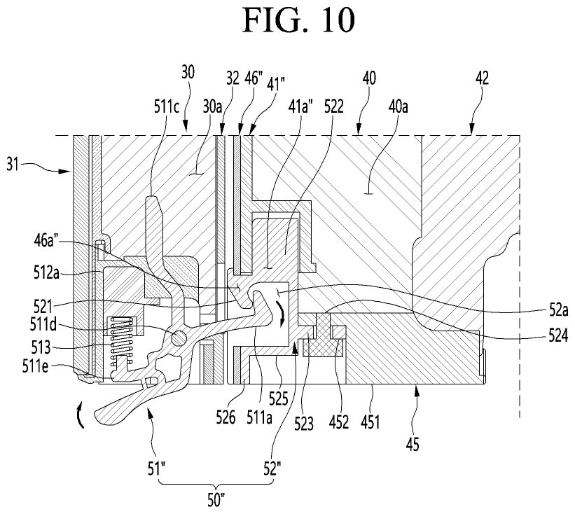

FIG. 10 is a partial cross-sectional view illustrating a door according to another embodiment.

Referring to FIG. 10, the frame cover 46″ according to the present embodiment may include a cover hole 46a″ located at the lower end part. In other words, the frame cover 46″ according to the present embodiment may include a cover hole 46a″ instead of a cover cutout part 46a, unlike the frame cover 46 according to one embodiment.

In this embodiment, the latch accommodation space 52a of the latch accommodation part 52′ can be placed at the rear of the frame cover 46″. Accordingly, the frame cover 46″ can minimize foreign substances from entering the latch accommodation space 52a.

In this embodiment, the latch accommodation part 52″ may further include a first latch support part 525 extending forward from the latch fastening part 523 and a second latch support part 526 extending downward from the front end of the first latch support part 525.

The first latch support part 525 can form the lower surface of the latch accommodation space 52a. The second latch support member 526 can support the rear surface of the frame cover 46″.

In addition, when the hook part 511a of the latch member 51″ is released from engagement, the downward movement may be restricted by the frame cover 46″ and the second latch support part 526. In other words, when the handle part 511b moves and the movement of the hook part 511a is restricted by the frame cover 46″ and the second latch support part 526, the engagement of the hook part 511a may be released. Accordingly, it can be known that the engagement of the hook part 511a is released even with a small rotation of the manipulation member 511, so that the sub-door part 30 can be opened more easily.

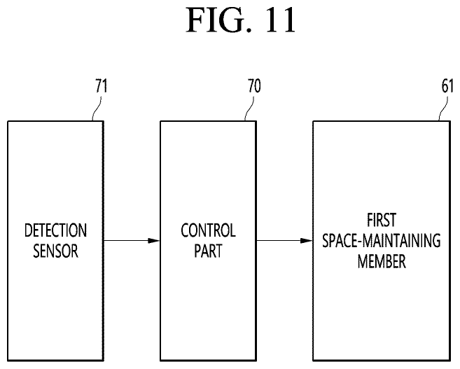

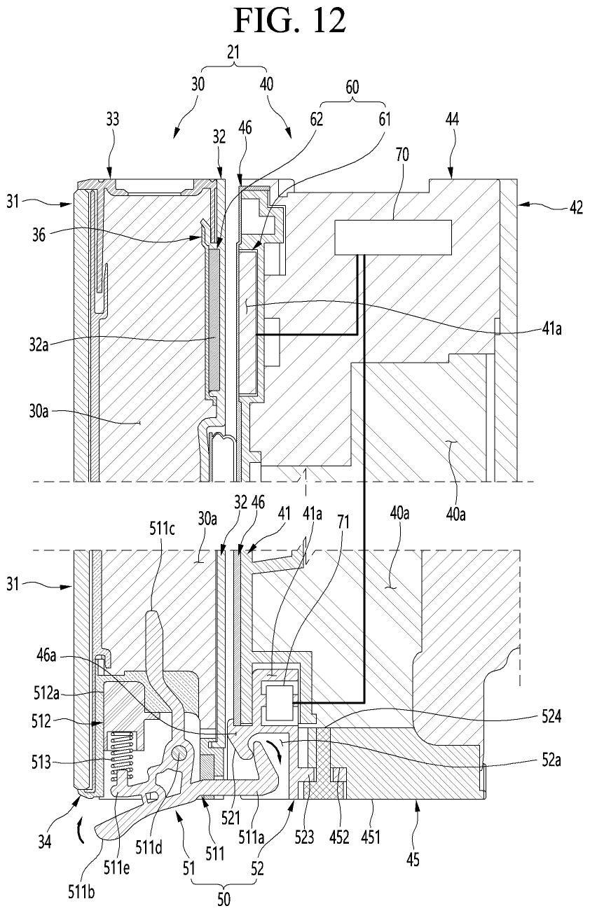

FIG. 11 is a control block diagram illustrating a door according to another embodiment, and FIG. 12 is a partial cross-sectional view illustrating a door according to an embodiment of FIG. 11.

Referring to FIGS. 11 and 12, the refrigerating compartment door 21 according to the present embodiment may further include a control part 70 and a detection sensor 71. The detection sensor 71 is a sensor that monitors the engagement of the hook part 511a with the latch restraint part 521, and the control part 70 may control the first space-maintaining member 61 based on information detected by the detection sensor 71. In the present embodiment, the first space-maintaining member 61 may have a magnetic force formed according to the control of the control part 70. For example, the first space-maintaining member 61 may be configured as an electromagnet.

For example, a detection sensor 71 may be provided in the latch accommodation part 52. The detection sensor 71 may provide information on whether the hook part 511a of the latch member 51 is engaged with the latch restraint part 521 to the control part 70.

The control part 70 can control the first space-maintaining member 61 based on information provided from the detection sensor 71. Specifically, when the hook part 511a is restrained by the latch restraint part 521, the control part 70 can control the first space-maintaining member 61 to form a magnetic field. Meanwhile, when the hook part 511a is released from restraint by the latch restraint part 521, the control part 70 can control the first space-maintaining member 61 not to form a magnetic field.

In other words, the detection sensor 71 and the control part 70 can cause the attractive force to be applied between the first space-maintaining member 61 and the second space-maintaining member 62 only when the sub-door part 30 is closed. Therefore, the refrigerating compartment door 21 according to the present embodiment eliminates the attractive force by the space-maintaining member 60 when the sub-door part 30 is opened, so that the sub-door part 30 can be opened more easily.

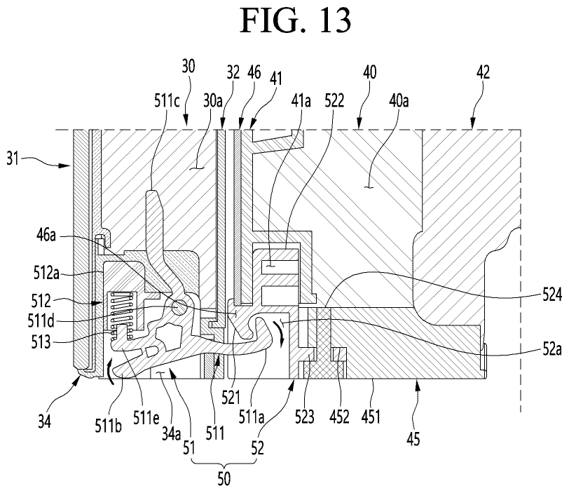

FIG. 13 is a partial cross-sectional view illustrating a door according to another embodiment.

Referring to FIG. 13, the refrigerating compartment door 21 according to this embodiment may include a latch member 51 that is coupled so as not to be visible from the front. In this embodiment, The handle part 511b of the manipulation member 511 included in the latch member 51 may not be visible from the front of the refrigerating compartment door 21. For example, The handle part 511b of the manipulation member 511 can be located inside the lower bracket groove 34a. The lower end of the handle part 511b of the manipulation member 511 may be positioned or aligned above the lower end of the lower bracket 34.

The refrigerating compartment door 21 according to the present embodiment can further improve the outer appearance of the refrigerating compartment door 21 by preventing the latch member 51 from being visible from the front through the structure.

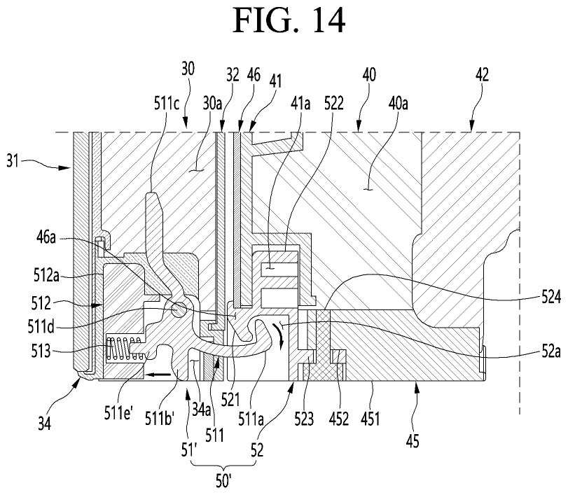

FIG. 14 is a partial cross-sectional view illustrating a door according to another embodiment.

Referring to FIG. 14, the refrigerating compartment door 21 according to the present embodiment may have a manipulation member 511 including a handle part 511b′ configured to be pulled from the rear toward the front. In this embodiment, The handle part 511b′ of the manipulation member 511 may have a shape extending downward from the rotation shaft 511d.

In addition, the elastic member support part 511e′ of the manipulation member 511 can be located in front of the handle part 511b′. In front of the elastic member support part 511e′, an elastic member 513 configured to stretch in the front and rear direction can be coupled. Therefore, The refrigerating compartment door 21 according to the present embodiment can be configured so that the handle part 511b′ of the manipulation member 511 included in the latch member 51′ moves in the front and rear direction.

Meanwhile, in the present embodiment, the handle part 511b′ of the manipulation member 511 included in the latch member 51′ may not be visible from the front of the refrigerating compartment door 21. For example, the handle part 511b′ of the manipulation member 511 may be located inside the lower bracket groove 34a. The lower end of the handle part 511b′ of the manipulation member 511 may be located or aligned above the lower end of the lower bracket 34.

The refrigerating compartment door 21 according to this embodiment can open the sub-door part 30 by moving the handle part 511b′ at various angles through the structure. In addition, the outer appearance of the refrigerating compartment door 21 can be further improved by preventing the latch member 51 from being visible from the front.

What is claimed is:

1. A refrigerator comprising:
a cabinet forming a storage space; and
a door rotatably connected to the cabinet,
wherein the door includes:
a main-door part rotatably coupled to the cabinet;
a sub-door part rotatably coupled to the main-door part;
a latch accommodation part provided at a lower end part of the main-door part;
a latch member provided at a lower end part of the sub-door part and detachably engaged to the latch accommodation part;
a first space-maintaining member provided on an upper end part of the main-door part; and
a second space-maintaining member provided on an upper end part of the sub-door part and disposed facing the first space-maintaining member.

2. The refrigerator of claim 1,
wherein the first space-maintaining member and the second space-maintaining member are magnets forming a mutual attractive force.

3. The refrigerator of claim 1,
wherein one of the first space-maintaining member and the second space-maintaining member is a magnet, and
wherein the other of the first space-maintaining member and the second space-maintaining member is a magnetic material forming an attractive force with the magnet.

4. The refrigerator of claim 1, further comprising:
a detection member provided in the latch accommodation part and configured to detect an engagement between the latch member and the latch accommodation part; and
a control part configured to control the first space-maintaining member based on information provided from the detection member,
wherein the first space-maintaining member is an electromagnet,
wherein the second space-maintaining member is a magnetic material configured to form an attractive force with a magnet, and
wherein the control part controls so that the first space-maintaining member has a magnetic force when the latch member and the latch accommodation part are engaged, and so that the first space-maintaining member does not have a magnetic force when the latch member and the latch accommodation part are not engaged.

5. The refrigerator of claim 1,
wherein, in a state where the latch member and the latch accommodation part are engaged, a distance between the first space-maintaining member and the second space-maintaining member is minimum.

6. The refrigerator of claim 1,
wherein the main-door part includes:
a door frame provided on a front surface of the main-door part and including a first accommodation part in which the first space-maintaining member provided; and
a frame cover coupled to a front surface of the door frame and configured to cover the first accommodation part.

7. The refrigerator of claim 6,
wherein the sub-door part includes:
a panel;
a sub-door liner to which the panel is coupled and forming a rear surface of the sub-door part;
an upper bracket forming an upper surface of the sub-door part;
a lower bracket forming a lower surface of the sub-door part; and
an insulation material formed by filling a foam liquid in a space formed by the coupling of the panel, the sub-door liner, the upper bracket, and the lower bracket,
wherein a second accommodation part in which the second space-maintaining member is received, is formed on a front surface of the sub-door liner, and
wherein the second accommodation part is shielded by a shielding member to prevent penetration of the insulation material.

8. The refrigerator of claim 7,
wherein the panel includes:
a see-through part configured to be viewable inside; and
a bezel part disposed to surround the see-through part, and
wherein the second space-maintaining member is disposed at a rear of the bezel part.

9. The refrigerator of claim 7,
wherein the first space-maintaining member and the second space-maintaining member are magnets forming a mutual attraction force, and
wherein the shielding member is made of a material through which magnetic fields pass.

10. The refrigerator of claim 7,
wherein the latch member includes:
a latch housing mounted on the lower bracket; and
a manipulation member rotatably coupled to the latch housing and engaging with and disengaging from the latch accommodation part by a user's manipulation.

11. The refrigerator of claim 6,
wherein the main-door part includes:
a door liner forming a rear surface of the main-door part;
a side frame forming a side of the main-door part;
an upper cap decoration forming an upper surface of the main-door part; and
a lower cap decoration forming a lower surface of the main-door part, and
wherein the latch accommodation part is mounted on the lower cap decoration.

12. The refrigerator of claim 11,
wherein at a lower end part of the frame cover, a cover cutout part is formed that is recessed upward so that the latch accommodation part is partially inserted, and
wherein the latch member is engaged to the latch accommodation part through the cover cutout part.

13. The refrigerator of claim 11,
wherein the latch accommodation part is located lower than a lower end part of the frame cover.

14. The refrigerator of claim 11,
wherein at the lower end part of the frame cover, a cover hole is formed so that the latch accommodation part is exposed forward, and
wherein the latch member is engaged to the latch accommodation part through the cover hole.

15. The refrigerator of claim 11,
wherein the first accommodation part is located in front of the upper cap decoration.

16. The refrigerator of claim 11,
wherein the latch accommodation part includes:
a latch restraint part in which the latch member is engaged;
a latch insertion part inserted into a lower end part of the door frame and restrained from moving in a front and rear direction; and
a latch mounting part formed to protrude to one side from the latch restraint part and mounted on the lower cap decoration.

17. The refrigerator of claim 6,
wherein the first space-maintaining member and the second space-maintaining member are magnets forming a mutual attraction force, and
wherein the frame cover is made of a material through which magnetic fields pass.
